(19) United States
(12) Patent Application Publication
(10) Pub. No.: US 2006/0149610 A1
(43) Pub. Date: Jul. 6, 2006

(54) Visual representation of sub-intervals of time

(75) Inventors: Derik B. Stenerson, Redmond, WA (US); Ehud Pardo, Bellevue, WA (US)

Correspondence Address: MARSHALL, GERSTEIN & BORUN LLP (MICROSOFT), 233 SOUTH WACKER DRIVE, 6300 SEARS TOWER, CHICAGO, IL, 60606, US

(73) Assignee: MICROSOFT CORPORATION, Redmond, WA (US)

(21) Appl. No.: 11/026,718

(22) Filed: Dec. 30, 2004

(51) Int. Cl. G06F 9/46

(52) U.S. Cl. 705/8

(57) ABSTRACT

The method may include creating a first time span where a time span comprises a start time, an end time and an attribute, creating a second time span; wherein the end time of the first time span and the start time of the second time span are set according to an adjustment rule, allowing modification of the start times and end times, if the end time of the first time span has been modified, automatically adjusting the start time of the second time span according to the adjustment rule and if the start time of the second time span has been modified, automatically adjusting the end time of the first time span according to the adjustment rule.

### BACKGROUND

Efficiently using resources such as machines, people and computing power has long been a goal of business. As a result, attempts have been made to schedule resources to minimize conflicts and maximize the output of the resources. Computers have the potential to be useful in keeping track of complex and inter-related schedules but it has been a challenge to develop a simple to use system that is intuitive to use but can maintain complex schedules.

### SUMMARY

A method and apparatus for creating divisions of time is disclosed. The method may include creating a first time span where a time span comprises a start time, an end time and an attribute, creating a second time span; wherein the end time of the first time span and the start time of the second time span are automatically set according to an adjustment rule, allowing modification of the start times and end times, if the end time of the first time span has been modified, automatically adjusting the start time of the second time span according to the adjustment rule, and if the start time of the second time span has been modified, automatically adjusting the end time of the first time span according to the adjustment rule.

In addition, the method may include the adjustment rule as at least one of a slack-time and an identical time. The method may further include allowing the first time span and the second time span to be merged wherein the merged time span will have the start time of the first time span and the end time of the second time span, allowing for insertion of an additional time span with an additional attribute into the first time span, creating a new first time span with the first attribute, a second time span with the additional attribute and a third time span with the first attribute. Additionally, the method may include allowing the second time span to be removed by modifying the end of the first time span to be the same as the beginning of a third time span if there is a first time span, a second time span and a third time span and allowing the second time span to be merged with the first time span by modifying the end of the first time span to overlap the beginning of a third time span, the start time of the first time span and the end time of the third time span remaining unchanged. The first and third time spans may have a first attribute, and the second time span may have a second attribute.

The method may also include a time span with a first attribute to be split into a first time span and a second time span where both the first time span and the second time span have the first attribute. Furthermore, the method may also include automatically merging the first time span and second time span if the first time span and the second time span have the same attribute, displaying a result of merging the first time span and the second time span as a single row, displaying a result of inserting an additional time span into the first time span as three rows, and displaying a result of splitting a time span as two rows. A computer readable medium with computer executable instructions to execute the method is disclosed as is a computer system with a processor programmed to execute the method.

### DRAWINGS

FIG. 1 is a block diagram of a computing system that may operate in accordance with the claims;

FIG. 2 is flowchart of a method in accordance with the claims;

FIG. 3 is an illustration of a display of an interval of time in accordance with the claims;

FIG. 4 is an illustration of a display of a break inserted into an interval of time in accordance with the claims;

FIG. 5 is an illustration of a display of a change in the start time of an interval of time in accordance with the claims;

FIG. 6 is an illustration of a display of intervals of time and their attributes in accordance with the claims;

FIG. 7 is an illustration of a display of splitting an interval of time in accordance with the claims;

FIG. 8 is an illustration of a display of the results of splitting an interval of time in accordance with the claims;

FIG. 9 is an illustration of a display of updating an attribute in accordance with the claims;

FIG. 10 is an illustration of a display of merging two intervals of time in accordance with the claims; and

FIG. 11 is an illustration of a display of removing an interval of time in accordance with the claims.

### DESCRIPTION

Although the following text sets forth a detailed description of numerous different embodiments, it should be understood that the legal scope of the description is defined by the words of the claims set forth at the end of this patent. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. § 112, sixth paragraph.

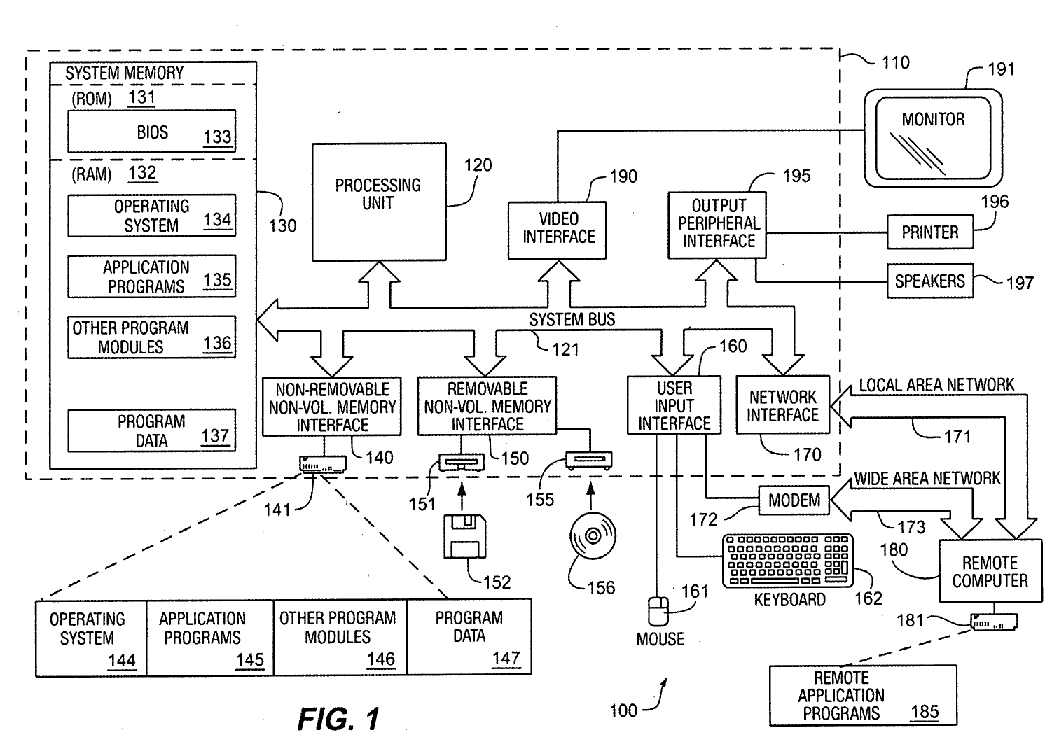

FIG. 1 illustrates an example of a suitable computing system environment 100 on which a system for the steps of the claimed method and apparatus may be implemented. The computing system environment 100 is only one example of a suitable computing environment and is not intended to suggest any limitation as to the scope of use or functionality of the method of apparatus of the claims. Neither should the computing environment 100 be interpreted as having any dependency or requirement relating to any one or combination of components illustrated in the exemplary operating environment 100.

The steps of the claimed method and apparatus are operational with numerous other general purpose or special purpose computing system environments or configurations. Examples of well known computing systems, environments, and/or configurations that may be suitable for use with the methods or apparatus of the claims include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The steps of the claimed method and apparatus may be described in the general context of computer-executable instructions, such as program modules, being executed by a computer. Generally, program modules include routines, programs, objects, components, data structures, etc. that perform particular tasks or implement particular abstract data types. The methods and apparatus may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing the steps of the claimed method and apparatus includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 140 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 20 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

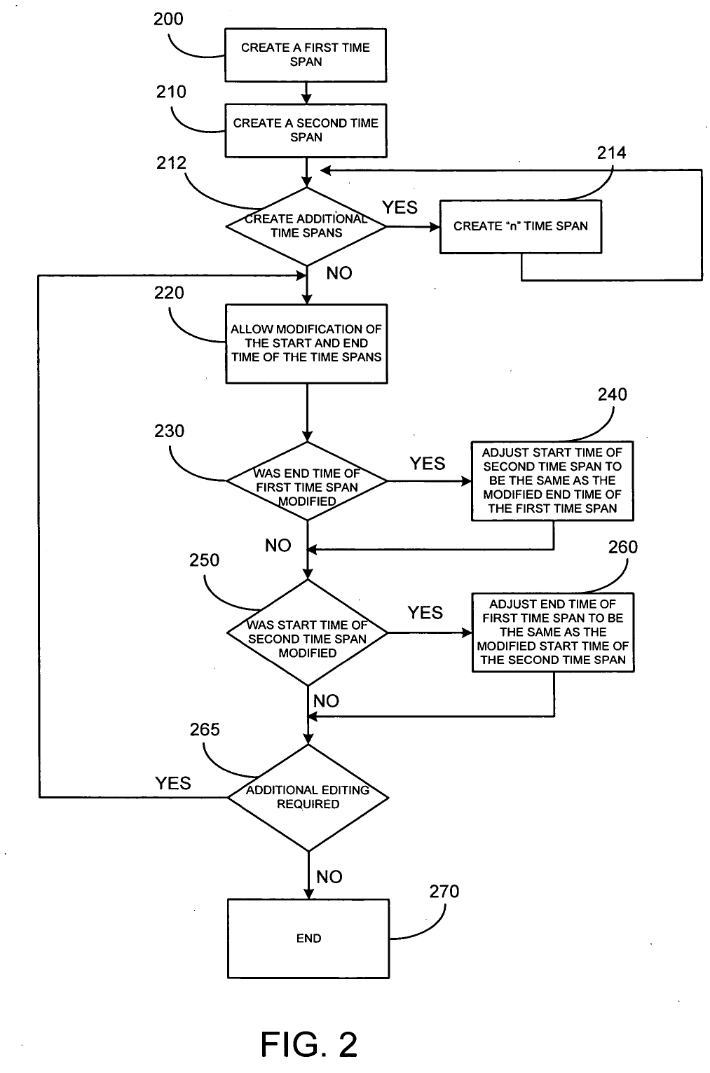

FIG. 2 may be an illustration of a method in accordance with the claims. At block 200 a first time span may be created where a time span comprises a start time, an end time, and an attribute. The time span can be any traditionally known time span such as a year, a month, a day or working hours. The start time and end time define the length of the time span. Different time spans can also be named and created. For example, a first time span may be for working hours, a second time span may be for overtime hours, and a third time span may be for nonworking hours all during the same day. An attribute may be a description regarding what is occurring during that time span. For example, during a certain time span, a user may be listed as working or the user may be working as having lunch. Additional detail may be added, such as how much capacity the user has during that period of time. For example, a user may be listed as working during a certain span, but may only have enough work to be 50% of capacity.

At block 210 a second time span may be created where the end time of the first time span is the same as the start time of the second span. At block 212 a determination may be made whether additional time spans are needed. If more time spans are needed, control may pass to block 214 where an “n^{th}” time span may be created. Adjacent start and stop times may be set, or automatically modified, according to an adjustment rule. For an adjustment rule of ‘identical-time,’ the adjacent times are equal to each other. For example, if the first time span ends at 12:00 p.m., the second time span will begin at 12:00 p.m. An adjustment rule of ‘slack-time’, on the other hand, introduces a time delay between adjacent time spans. For example, if the first time span ends at 12:00 p.m., the second time span may begin at 12:05 p.m. if the slack-time is set for five minutes. Various durations of slack-time may be established as a default, or a specific user setting.

At block 220 modification of the start times and end times may be allowed. This modification may be permitted through a variety of ways. For example, a drop-down box listing times may be used to adjust the start times and end times of the first time span and the second time span. In an alternative embodiment, an input box may be used wherein a start time and end time may be entered into the system. In yet another embodiment, the start time of the first time span and the end time of the second time span may be modified at block 220.

At block 230 a determination may be made whether the end time of the first time span was modified. If the end time of the first time span was not modified, control may pass to block 250. If the end time of the first time span was modified, at block 240 the start time of the second time span may be adjusted to be the same, or a slack-time, as the modified end time of the first time span. For example, if the first time span was listed end at 12:00 p.m. and its end time was modified to be changed to 1:00 p.m., the start time of the second time span would automatically be adjusted to be 1:00 p.m., or in the case of a slack-time, the second time span may be automatically adjusted to an offset value, e.g., 1:05 p.m.

At block 250, a determination may be made whether the start time of the second time span has been modified. If the start time of the second time span has not been modified, control may pass to block 265 where the method may determine if further editing should occur. If further editing should occur, control may pass to block 220, otherwise control may pass to block 270 where the method may end. If the start time of the second time span has been modified, control may pass to block 260 where the end time of the first time span may be automatically adjusted to be the same as the modified start time of the second time span, or adjusted according to an offset. For example, if the start time of the second time span was 12:00 p.m. and was modified to 2:00 p.m., the end time of the first time span would automatically be adjusted to be 2:00 p.m.

In addition, time spans can be merged. For example, the first time span and second time span may be merged into a single time span. The results of the merge of the first time span and second time span will be a time span with the start time of the first time span and the end time of the second time span. In some cases, the first time span and the second time span will not have the same attribute. For example, the first time span may show that an employee is working and the second time span may indicate that the employee is on break. When the time spans are merged, there may be a default rule regarding which attribute will be the attribute of the new time span. For example, one possible rule would be that the attribute of the first time period will be assigned to the new time span. Another rule would be that the attribute of the second time span is added to the new merged time span. Another possible rule would be that breaks would be eliminated whenever two time spans are merged.

Yet another option is to allow a user to select the attribute to be assigned to the new time span. Furthermore, an additional time span with an additional attribute can be inserted into a time span. For example, a first time span may cover from 8:00 a.m. to 5:00 p.m. which may indicate that a certain employee is working. The system may allow the insertion of a new time span within the first time span. For example, a break may be inserted from 12:00 p.m. to 1:00 p.m. indicating that a resource is on break. A result would be a new first time span from 8:00 a.m. to 12:00 p.m. with the attribute that would show the employee is working. A second time span would be created from 12:00 p.m. to 1:00 p.m. with the attribute which would indicate that the resource is on break and a third time span from 1:00 p.m. to 5:00 p.m. which would indicate the attribute that the resource is again working. This also may be referred to as inserting a break into a time span.

Similarly, a time span can be removed from the system. For example, if a first time span indicates that it covers from 8:00 a.m. to 12:00 p.m. and a second time span indicates that it covers from 12:00 p.m. to 1:00 p.m., the ending time of the first time span can be modified to be 1:00 p.m. The result will be that the first time span and the second time span will be merged into a single time span with the elimination of the second time span. In this case, as the second time span was removed, the attribute from the first time span will be assigned to the new time span.

Not surprisingly, the time span can be split into additional time spans. For example, a time span from 8:00 a.m. to 5:00 p.m. can be split into two time spans. For example, a first time span from 8:00 a.m. to 12:00 p.m. and a second time span from 12:00 p.m. to 5:00 p.m. In this example, both time spans may be assigned the same first attribute, although the attributes can be assigned according to rules created within the system, or by selection of the user.

In yet another example, a first time span and a second time span may be automatically merged into a single time span if the first time span and the second time span have the same attribute. For example, if a first time span covers 8:00 a.m. to 12:00 p.m., and the attribute is listed as working and the second time span covers from 12:00 p.m. to 5:00 p.m. and the attribute also indicates that the employee is working, the system may automatically combine the first and second time spans into a single time span with the indicated attribute as being working. This option may be enabled or disabled by a user.

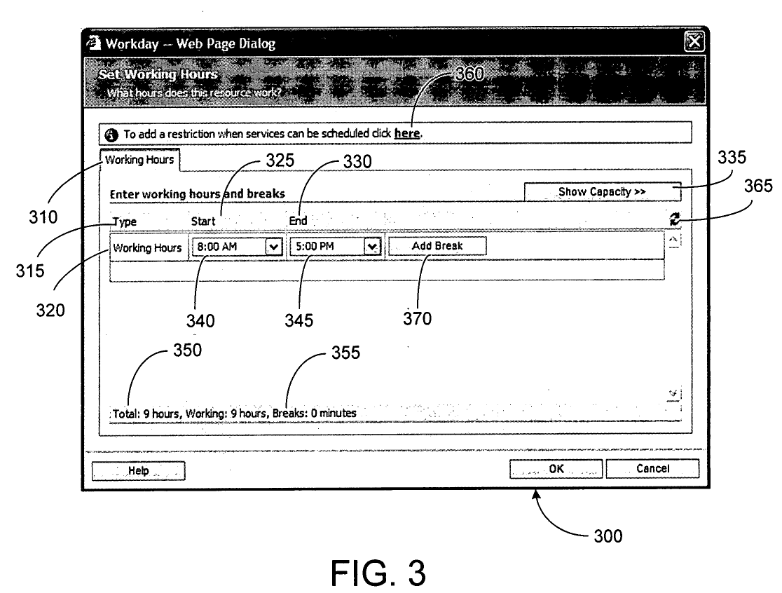

FIG. 3 may be an illustration of a display of a first time span. The display 300 may have various options presented to a user. For example, tab 310 may allow a user to see working hours, which may be predefined in the system. The hours selected may also be indicated under the type symbol 315 and may be shown in the box below the type heading 320. There also may be a heading for start time 325 and end time 330. There may also be the option for a user to see the capacity of the employee by selecting a show capacity button 335. A drop-down or combo box may be under the start heading which may allow a user to modify a first start time 340. The drop-down box may also be replaced with a simple input field or any other suitable input device. A similar input field may be under the end heading 345. The display may also indicate how many hours in total a person is scheduled to work 350 and how many breaks an employee is scheduled to take 355. The display may also provide an option for a user to add a restriction on when services can be scheduled 360. For example, a certain time span may be blocked from having anyone schedule a time during that time span. A user may also be able to refresh the display and the totals by clicking a refresh button 365 in which the totals for working hours 350 and breaks 355 may be recalculated. A user may also be presented the option to add a break to a time span by clicking an add break button 370.

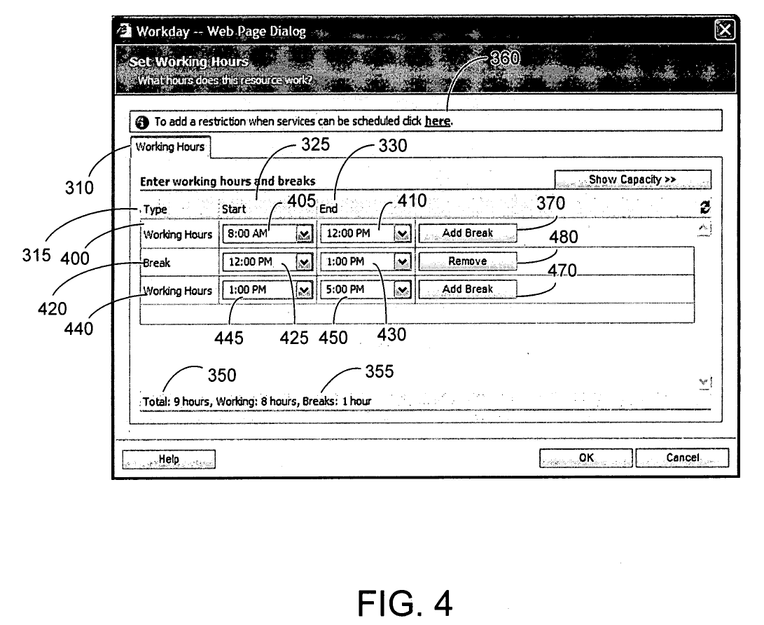

FIG. 4 may be an illustration of the result of selecting the add break button 370 from FIG. 3. Previously in FIG. 3, the resource was indicated as having a first time span from 8:00 a.m. to 5:00 p.m. which was listed as working hours. By selecting the add break option 370, three time spans are now indicated. A first time span 400 indicates a first period of working hours from 8:00 a.m. 405 to 12:00 p.m. 410, a second time span 420, which is listed as being a break, from 12:00 p.m. 425 to 1:00 p.m. 430 and a third time span 440, listed as working hours, from 1:00 p.m. 445 to an end time of 5:00 p.m. 450. As a result of adding a break, the total hours is now indicated as being 9 hours 350. The working hours are now listed as being 8 and breaks are being listed as being 1 hour 355.

FIG. 4 also illustrates that additional breaks can be added to working hours by clicking the add break button 370 again in both the first time span and third time span 470. In addition, a user can remove the break by selecting the remove button 480.

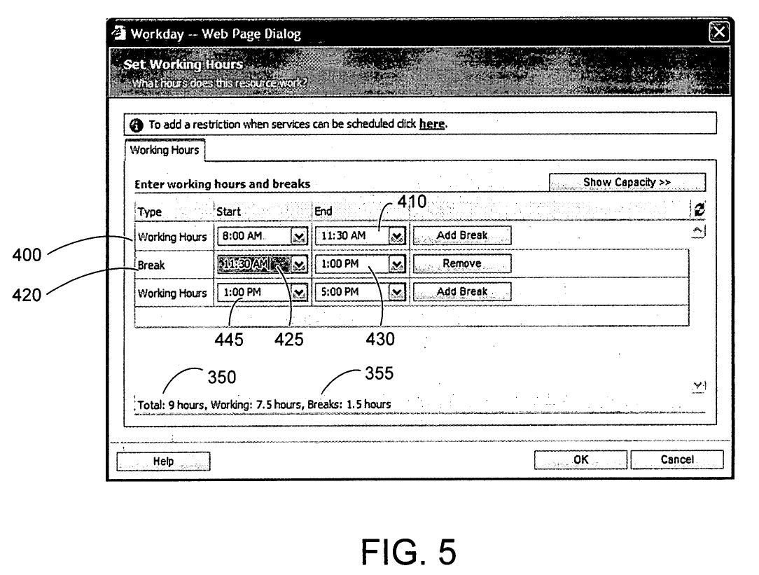

FIG. 5 may be an illustration of the result of changing a start time of a second time span 420, automatic update of the end time of the first time span 400. In this example, the start time 425 for the second time span 420 was adjusted to 11:30 a.m. As a result, the end time 410 of the first time span 400 was automatically changed to be the same time 11:30 a.m. In addition, the total 350 continues to indicate that total time available is 9 hours. However, 7.5 hours are now indicated as being for working and 1.5 hours is indicated as being for a break 355. In an alternative embodiment, not shown, a time span may include a rule in which its duration must not change, although its start and end times may change. For example, the second time span 420 may include a rule in which its duration should not deviate from one hour. After changing the start time 425 of the second time span 420 to 11:30 a.m., as discussed earlier, not only would the end time 410 of the first time span 400 automatically adjust to 11:30 a.m., but the end time 430 of the second time span 420 would automatically adjust to 12:30 p.m. to comply with the one hour duration rule for that time span.

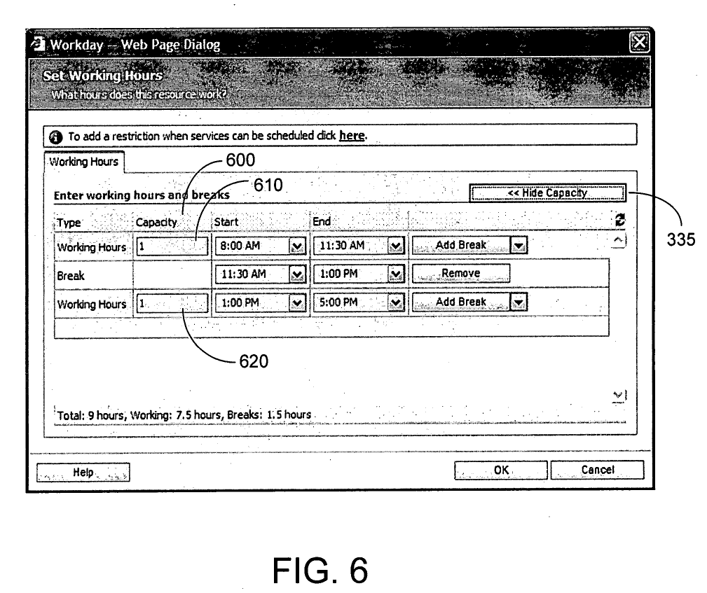

FIG. 6 may be an illustration of the result of selecting the show capacity tab 335. As a result, a new column is added to the display with the heading of capacity 600. In addition, each time span now has a capacity box. In this example, during a first time span, capacity is showing as being a level 1 610 and during a third time span, capacity is showing as also being a level 1 620. In this example, there is no capacity displayed for breaks. This may be set up as a default value when the system is installed. Capacity is just one example of attributes that can be attached to a time span.

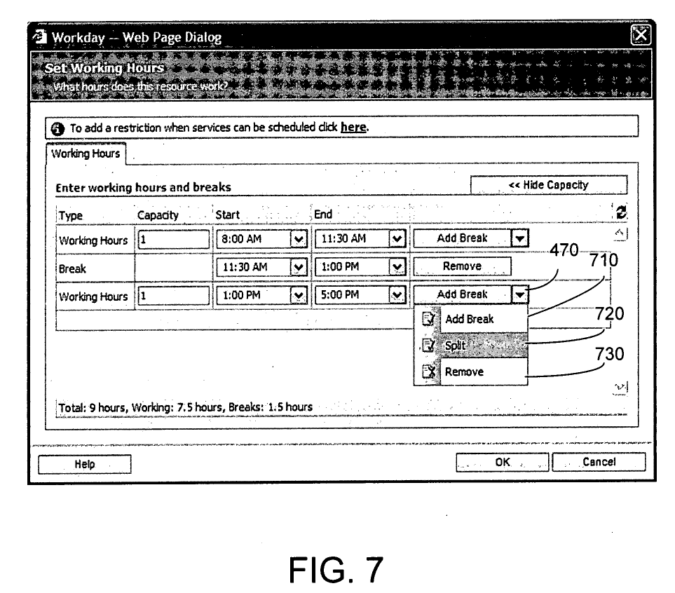

FIG. 7 may be an illustration of the result of selecting the add break split button 470 and a third time span. By selecting the drop-down box, a user is presented with three options. First the user may add a break 710, the user may split the time span 720, or the user may remove the time span entirely 730.

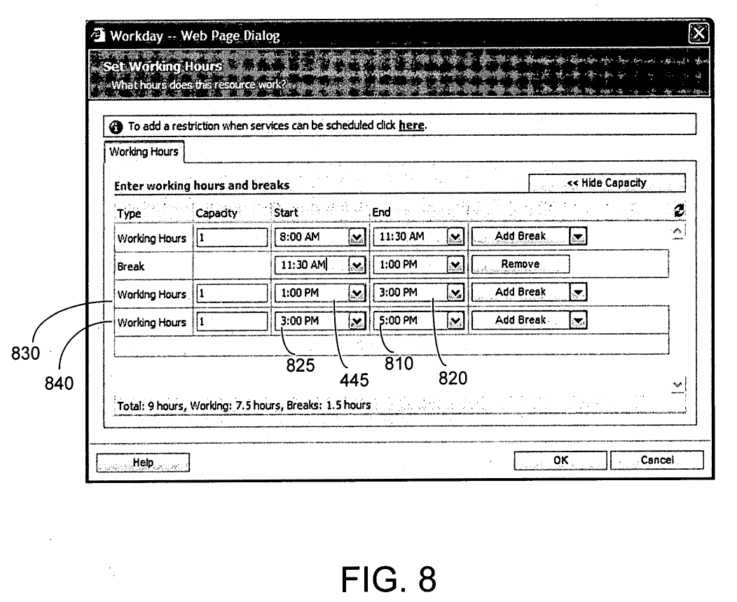

FIG. 8 may illustrate the results of selecting to split the third time span. As a result, the start time 445 of the third time span may be the same (1:00 p.m.) and the end time of the fourth time span may be the same as the previous third time span 810 (5:00 p.m.). However, a new end time has been added to the third time span 820 (3:00 p.m.) and a new start time has been added to the fourth time span 825 (3:00 p.m.). As a result, the previous third time span 420 has now been split into two time spans, specifically a new third time span 830 is listed and a new fourth time span 840 is listed with the third time span covering from 1:00 p.m. to 3:00 p.m. and the fourth time span covering from 3:00 p.m. to 5:00 p.m.

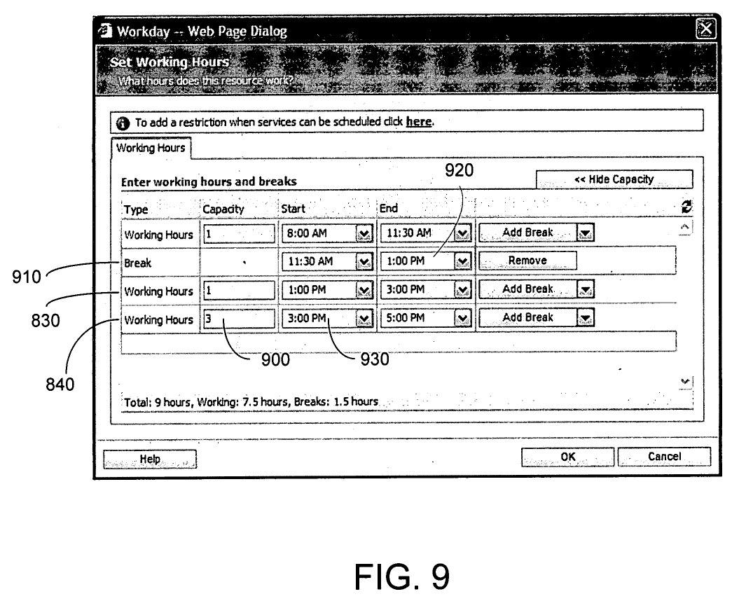

FIG. 9 may be an illustration of the ability of a user to update capacity during a time span. In FIG. 8, capacity during a fourth time span was indicated as being at level 1. In FIG. 9, in the capacity box 900, capacity has been updated to a level 3.

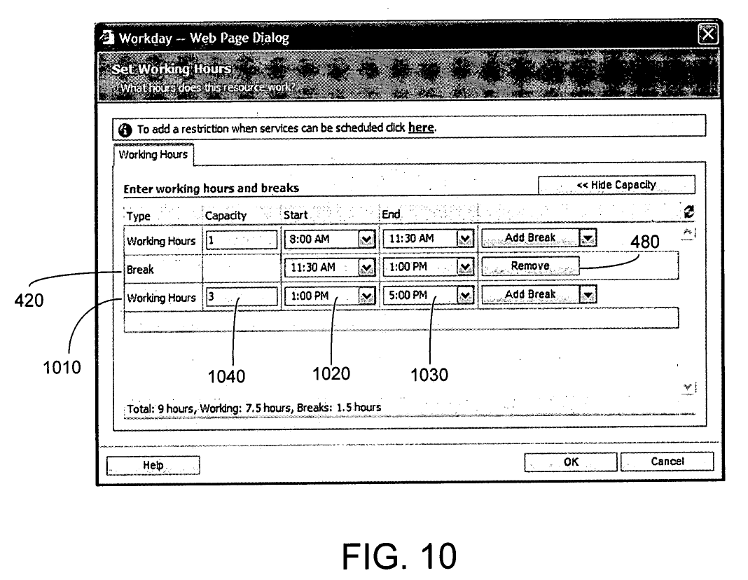

FIG. 10 may be an illustration of merging two time spans. In FIG. 9, the third time span 830 was indicated as covering from 1:00 p.m. to 3:00 p.m. and the fourth time span 840 was indicated as covering from 3:00 p.m. to 5:00 p.m. and the capacity of the third time span was indicated as being level 1 and the capacity of the fourth time span was indicated as being level 3. FIG. 10 indicates the results of merging the third time span 830 and the forth time span 840 into a new third time span 1010. The third time span 1010 indicates a start time of 1:00 p.m. 1020 and an end time of 5:00 p.m. 1030. In addition, the capacity for the new third time span 1010 is indicated as being level 3 1040. As previously discussed, the attribute to be assigned to the new merged row can be accomplished by following predetermined rules or set by a user. In this example, the capacity attribute from the fourth time span 840 was carried over to cover the new third time span 1040. Another potential rule may be a higher capacity level of two merged rows will be the result of the new merged row. Another possible example would be the lower capacity level would be assigned to the capacity of the new merged row.

Certainly other possibilities are available. One of which, not shown, may automatically merge time spans when a start or end time is changed to completely overlap one or more adjacent time spans. In FIG. 9, the second time span 910 was indicated as covering from 11:30 a.m. to 1:00 p.m. and the third time span 830 was indicated as covering from 1:00 p.m. to 3:00 p.m. and the fourth time span 840 was indicated as covering from 3:00 p.m. to 5:00 p.m. If the end time 920 of the second time span 910 was adjusted to 3:15 p.m., the fourth time span 840 start time 930 would automatically change to 3:15 p.m. and merge the second time span 910 with the third time span 830. This would result in only two time spans remaining. While this example illustrates overlapping two time spans, the overlapping effect is independent of the number of time spans.

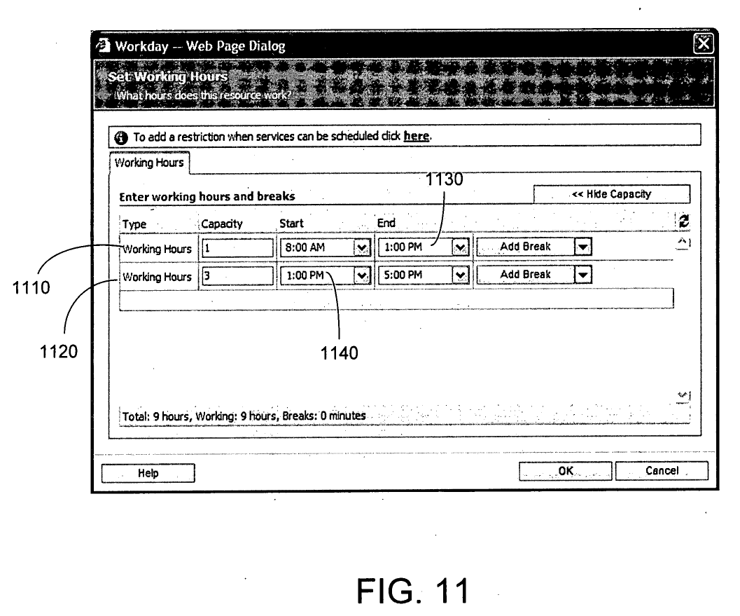

FIG. 11 may be an illustration of removing a break 420 such as a break indicated in FIG. 4 and in FIG. 10. In FIG. 10, the second time span is indicated as being a break 420 and a remove button is indicated as being displayed next to the second time span 480. By selecting the remove button 480, the second time span 420 is removed. The result is a first time span 1110 and a second time span 1120. The end time of the first time span is adjusted to include the time that previously was assigned to a break 1130 and the start time of the third time span from FIG. 10 becomes the start time of the second time span in FIG. 11 as indicated by element 1140 and this remains the same at 1:00 p.m. The addition of the time span from the break to the first time span may be governed by a default rule or may be set up by the user initially or may be selected at the time that the break is removed. In another example, the start time of the break 420 may be added to the working time of the third time span 1010 in FIG. 10.

The system is not just limited to being used by a single user. The system can be viewed by multiple users including managers and employees. The managers can view just how busy employees are during the day including their capacities and their planned breaks. In addition, employees can see how busy employers plan for them to be during the day. In addition, the system is not just limited to employee-type resources, but also may be used for a specific machine. For example, if a key machine is used in a process, it may be especially useful to see availability of that machine in view of the capacity of that machine during the day. In addition, the system may be useful for budgeting as a personal department may be able to view, in advance, how much an employee plans to work during a day, or during a week, or during a month which may help in budgeting and cash flow concerns. Furthermore, the system is simple to use with the automatic updating of start times and end times of time spans making adjusting schedules especially easy and simple and easy to understand.

Although the forgoing text sets forth a detailed description of numerous different embodiments, it should be understood that the scope of the patent is defined by the words of the claims set forth at the end of this patent. The detailed description is to be construed as exemplary only and does not describe every possible embodiment because describing every possible embodiment would be impractical, if not impossible. Numerous alternative embodiments could be implemented, using either current technology or technology developed after the filing date of this patent, which would still fall within the scope of the claims.

Thus, many modifications and variations may be made in the techniques and structures described and illustrated herein without departing from the spirit and scope of the present claims. Accordingly, it should be understood that the methods and apparatus described herein are illustrative only and are not limiting upon the scope of the claims.

1. A method for creating divisions of time, comprising:
creating a first time span where a time span comprises a start time, an end time and an attribute;
creating a second time span; wherein the end time of the first time span and the start time of the second time span are automatically set according to an adjustment rule;
allowing modification of the start times and end times;
if the end time of the first time span has been modified, automatically adjusting the start time of the second time span according to the adjustment rule; and
if the start time of the second time span has been modified, automatically adjusting the end time of the first time span according to the adjustment rule.

2. The method of claim 1, wherein the adjustment rule is at least one of a slack-time and an identical-time.

3. The method of claim 1, further comprising allowing the first time span and the second time span to be merged wherein the merged time span will have the start time of the first time span and the end time of the second time span.

4. The method of claim 1, further comprising inserting an additional time span with an additional attribute into the first time span, creating a new first time span with the first attribute, a second time span with the additional attribute and a third time span with the first attribute.

5. The method of claim 1, further comprising allowing the second time span to be removed by modifying the end of the first time span to be the same as the beginning of a third time span if there is a first time span, a second time span and a third time span.

6. The method of claim 1, further comprising allowing the second time span to be merged with the first time span by modifying the end of the first time span to overlap the beginning of a third time span, the start time of the first time span and the end time of the third time span remaining unchanged.

7. The method of claim 6, wherein the first and third time spans have a first attribute and the second time span has a second attribute.

8. The method of claim 1, further comprising allowing a time span with a first attribute to be split into a first time span and a second time span where both the first time span and the second time span have the first attribute.

9. The method of claim 1, further comprising automatically merging the first time span and second time span if the first time span and the second time span have the same attribute.

10. The method of claim 1, further comprising displaying a result of merging the first time span and the second time span as a single row.

11. The method of claim 1, further comprising displaying a result of inserting an additional time span into the first time span as three rows.

12. The method of claim 1, further comprising displaying a result of splitting a time span as two rows.

13. A computer readable medium having computer executable instructions for creating divisions of time comprising:
computer executable instructions for creating a first time span where a time span comprises a start time, an end time and an attribute;
computer executable instructions for creating a second time span; wherein the end time of the first time span and the start time of the second time span are set according to an adjustment rule;
computer executable instructions for allowing modification of the start times and end times;
if the end time of the first time span has been modified, computer executable instructions for automatically adjusting the start time of the second time span according to the adjustment rule; and
if the start time of the second time span has been modified, computer executable instructions for automatically adjusting the end time of the first time span according to the adjustment rule.

14. The computer readable medium of claim 13, wherein the adjustment rule is at least one of a slack-time and an identical-time.

15. The computer readable medium of claim 13, further comprising computer executable instructions for allowing the first time span and the second time span to be merged wherein the merged time span will have the start time of the first time span and the end time of the second time span.

16. The computer readable medium of claim 13, further comprising computer executable instructions for inserting an additional time span with an additional attribute into the first time span, creating a new first time span with the first attribute, a second time span with the additional attribute and a third time span with the first attribute.

17. The computer readable medium of claim 13, further comprising computer executable instructions for allowing the second time span to be removed by modifying the end of the first time span to be the same as the beginning of a third time span if there is a first time span, a second time span and a third time span.

18. The computer readable medium of claim 13, further comprising computer executable instructions for allowing a time span with a first attribute to be split into a first time span and a second time span where both the first time span and the second time span have the first attribute.

19. A computing apparatus, comprising:
a display unit that is capable of generating video images;
an input device;
a processing apparatus operatively coupled to said display unit and said input device, said processing apparatus comprising a processor and a memory operatively coupled to said processor,
a network interface connected to a network and to the processing apparatus;
said processing apparatus being programmed to create a first time span where a time span comprises a start time, an end time and an attribute;
said processing apparatus being programmed to create a second time span; wherein the end time of the first time span and the start time of the second time span are automatically set according to an adjustment rule;
said processing apparatus being programmed to allow modification of the start times and end times;
if the end time of the first time span has been modified, said processing apparatus being programmed to automatically adjust the start time of the second time span according to the adjustment rule; and
if the start time of the second time span has been modified, said processing apparatus being programmed to automatically adjust the end time of the first time span according to the adjustment rule.

20. The computing apparatus of claim 19, wherein the adjustment rule is at least one of a slack-time and an identical-time.
